(19) United States
(12) Patent Application Publication
(10) Pub. No.: US 2012/0083335 A1
(43) Pub. Date: Apr. 5, 2012

(54) GENERATION OF ANIMATION PLAYBACK SEQUENCES FOR ONLINE GAME ACHIEVEMENTS

(76) Inventors: Matthew Adam Ocko, Palo Alto, CA (US); Frank Randall Farmer, Palo Alto, CA (US)

(21) Appl. No.: 13/244,784

(22) Filed: Sep. 26, 2011

Related U.S. Application Data
(63) Continuation of application No. 12/898,382, filed on Oct. 5, 2010.

(51) Int. Cl. A63F 13/00

(52) U.S. Cl. 463/31

(57) ABSTRACT

Example systems and methods related to the generation of animation playback sequences of events constituting a player achievement in an online game are presented. In an example, events resulting from actions of a player in an online game are captured. Event records are generated for the captured events. An achievement of the player in the online game is detected. The achievement results from at least some of the captured events. At least some of the event records are aggregated to generate an achievement playback sequence for playback of at least some of the captured events resulting in the achievement.

### CLAIM OF PRIORITY

This application is a continuation of U.S. patent application Ser. No. 12/898,382, entitled “SYSTEM AND METHOD FOR GENERATING ACHIEVEMENT OBJECTS ENCAPSULATING EVENT PLAYBACK,” and filed Oct. 5, 2010, which is hereby incorporated herein by reference in its entirety.

### TECHNICAL FIELD

The present disclosure relates in general to capturing and manipulating events for playback after an achievement in a game is reached.

### BACKGROUND OF THE INVENTION

Multiuser online games are popular and are well-known in the art. In some implementations, there is a server that controls aspects of the game, such as who can become a player (i.e., a user that connects via a client device, computer or system to the server), the player's sensory inputs, player state (e.g., what virtual items the player's character possesses, what the character has done in the past, etc.), and player options (e.g., what the player or his character can do in the future).

Online games may be presented through a web browser (e.g., Microsoft Internet Explorer, Mozilla Firefox, Apple Safari, Google Chrome, and Opera, etc.) in the form of a website operable to accept and display user actions. These websites can be page-based and take the form of static pages encoded in Hyper Text Markup Language (HTML). The pages could also be encoded with Java, JavaScript, VBScript, PHP, or the like, thereby facilitating a significantly enhanced interactive experience for network users through dynamic web pages. As a further enhancement, the web page could include an excutable code object that can be processed by be a rendering engine, such as Adobe Flash created by Adobe Systems Inc. to present rich media content, animation, and interactivity to network users. Another type of game includes high-end graphics games that provide for near-video quality and/or three-dimensional rendering for a user experience that is even closer to reality. Thus, as shown, various technologies can be used to provide different levels of user interactivity and experience to the realm of computer-based gaming.

Regardless of the technology employed, many online games allow the user to interact with the game or with other users. For example, a user can perform various actions to advance his position in the game. Some of these actions may lead to desired actions, such as accomplishing a particular task. Similarly, accomplishing one or more of such tasks can lead to a particular achievement later in the game. For example, a dragon fighting game may involve the user taking strikes at the dragon with a sword. Some of those strikes at the dragon may be successful while some others might miss the dragon altogether. Each successful strike takes the user one step closer to accomplishing the event of slaying the dragon. Further, slaying multiple dragons (e.g., 10 dragons) may signify reaching a particular achievement in the game. An achievement could also refer to a user reaching a certain level or status in a game.

In the context of such games, it may be desirable to present a notification to the user to inform or congratulate the user for reaching such a milestone. Also, it may be desirable to present notifications to other users that this user has reached an achievement. Such notifications can be ranked in order of significance. Of course, the significance of an achievement would depend on the game and the user environment. Such notifications have the effect of rewarding users who reach a certain achievement as well as encouraging other users to attain or surpass that achievement level. Similarly, users can learn their standing in the user community for the game based on how successful they are in the game. Such notifications play an important role in maintaining the success of online games by incentivizing further advances by users in the game and by creating an overall environment of competition between users.

### BRIEF DESCRIPTION OF THE DRAWINGS

For a more complete understanding of particular embodiments and their advantages, reference is now made to the following description, taken in conjunction with the accompanying drawings, in Which like reference numbers indicate like features, and:

FIG. 1 illustrates an example process flow for capturing events.

FIG. 2 illustrates an example process flow for generating achievement playback objects.

FIG. 3 illustrates a schematic view of an example web page for displaying achievements for a particular user.

FIG. 4 illustrates a schematic view of an example web page having a leader board for listing achievements of multiple users in a particular gaming community.

FIG. 5 illustrates a schematic view of an example event object editor for customizing playback events related to an achievement by a user.

FIG. 6 illustrates an example network environment.

FIG. 7 illustrates an example computer system architecture.

### DETAILED DESCRIPTION

The following exemplary embodiments are described and illustrated in conjunction with apparatuses, methods, systems, and software which are meant to be examples and illustrative, not limiting in scope. For example, the network environment set forth below is provided to illustrate how one particular implementation of the present disclosure might be employed.

As shown by the figures, a system has been developed that supports generating achievement objects which encapsulate captured event playback sequences.

Online gaming has evolved enormously since the creation of stable networks such as the Internet permitting users virtually anywhere to play against each other or at least in competition with each other. Thus, not surprisingly, the competitive nature of these games-and the availability of networking technologies have resulted in the creation of online gaming communities. As discussed above, often it may be desirable in these online gaming communities to notify users once they reach an achievement or milestone in the game. Similarly, to enhance competitiveness among users in the online gaming community, it may be desirable to present user achievements in a list or table.

While it is useful to present users a simple message notifying them that they have reached a particular achievement, it is even more valuable from a gaming standpoint for users to retrace the actions and events that led to the ultimate achievement. This allows the user to recount the steps or skill that the user employed to reach that achievement and share this with other users. In this regard, a playback of some or all of the actions and events leading up to the achievement is of significant utility. Likewise, it is useful in the context of listing achievements of multiple users in an online gaming community, to provide a playback of the achievement for other users to view. More so than providing a simple message indicating that a user has achieved a particular achievement, other users can gain glimpses into the steps or skill employed by that user to reach that achievement.

In the context of milestones in an online game, an achievement may comprise one or more events where each of those events, in turn, comprises one or more actions. In some implementations, game logic defines what events make an achievement and what actions fall into a given event. For example, slaying the last dragon in a series of ten may define an achievement, where the achievement comprises the events of slaying each dragon in the series of ten. Similarly, slaying each of those dragons in turn may comprise the actions of striking that specific dragon multiple times. Once the tenth dragon is stayed, it would be desirable to view the slaying of some or all of the dragons leading to the tenth and final slaying. This playback could be presented to the user himself upon reaching an achievement or to others in the user community. In particular embodiments, an achievement can occur through programmatic progression of the game or progression though the assistance of other users, as opposed to traditional advancement in an online game by user-initiated actions. For example, if a user plants a seed, the seed itself may eventually grow into a plant on its own even though the user is not actively playing the game or even logged into the online gaming system whatsoever. In other words, the online game is in effect taking an action in the game rather than the user. In such embodiments, it becomes even more desirable to view events contributing to an achievement in a later playback because the user may never have experienced those events in the first place.

Certain embodiments of the present disclosure are directed toward automatically forming a playback sequence of one or more actions and events that led up to an achievement after an achievement is reached. In particular embodiments, the playback sequence can be presented to the user who attained that achievement or posted to a list viewable by some or all users in the online gaming community. In certain embodiments, the list could be a ranking of user achievements according to some prioritization scheme for achievements employed by the particular game. Still other embodiments allow the user to customize the playback by allowing the user to perform various operations such as adding, deleting, or reordering events. Further, a user interface for certain embodiments could allow the user to insert comments in the form of text or audio, or review the event by playing it before it is incorporated into a final playback sequence.

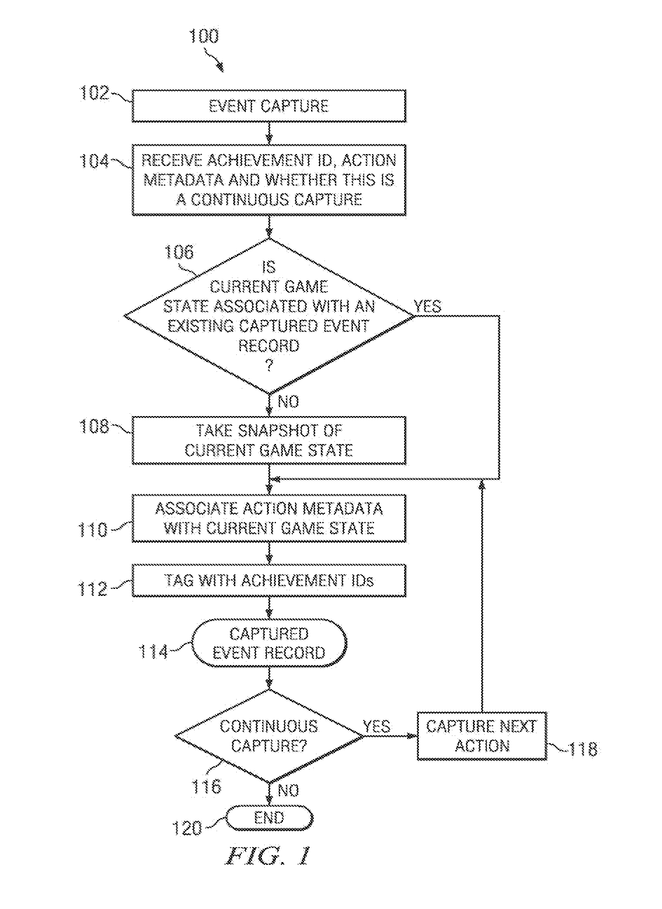

FIG. 1 illustrates a process flow for capturing events 100 which embodiments of the present disclosure may employ to capture events associated with an achievement. In one implementation, the process flow 100 may be implemented by a function or computer-executable module that is called at various times by game engine. When and how often the event capture module is called is subject to a variety of game design and engineering considerations and is defined at least in part by the game logic. Event capture begins generally at step 102. First, the event capture process receives in step 104 one or more achievement identifiers, action meta data and whether the current capture is a continuous or discrete capture. The achievement identifier identifies a particular achievement which comprises one or more events. Action metadata could be one or more parameters associated with a particular action. For example, action metadata may comprise a command executed by a user in the online game, positions and movements of various objects in the game environment, or other state information. In other words, action metadata is a set of information necessary in an online game to construct or reconstruct a specific action during playback. The indication of whether the current capture is continuous affects how many actions may be collected for the event capture. Specifically, a continuous capture records actions of the user continuously or periodically in time until the entire event is captured. In particular embodiments, continuous capture may also comprise capturing a sliding window of action metadata corresponding to actions that could contribute to an event. For instance, an online game may anticipate an upcoming event (e.g., slaying the fifth dragon) but is unsure how soon in time that event will actually take place. Accordingly, the game logic may programmatically capture a sliding window of action metadata (e.g., last 15 strikes at the dragon). Then, after the event occurs (e.g., actually slaying the fifth dragon), the action metadata presently in the sliding window will relate to a fix set of action metadata (e.g., the 15 strikes immediately prior to the fifth slaying) that can now properly be associated with that event. On the other hand, discrete captures record only certain actions by the user and associates it with the current event. Thus, with discrete captures, only relevant or desired actions are recorded and made part of a captured event record.

Next at step 106, the process determines whether the current game state is associated with an existing captured event record. In particular embodiments, game state refers to persistent positions and attributes of the objects in the gaming environment. In certain embodiments, the game state can also include the current execution point for a particular game. If the current game state is not associated with an existing captured event record, the process takes a snapshot of the current game state by recording various game state parameters in step 108. The process proceeds to step 110 where the action metadata is associated with the current game state. By making this association, the entire game environment related to that action, which contributes to the event, is captured for the purposes of later playback. Then in step 112, the record is tagged with one more achievement identifiers referring to a possible achievement that the user may reach at some later point in time. This tagging step permits the later playback of the event once an achievement actually occurs. As shown in step 114, once the current game state, action metadata, and achievement identifiers are properly associated with each other, the process creates a captured event record. The captured game state allows for generation or re-creation of animated sequences that relate to an event, such as the moments leading up to and including the slaying of a particular dragon or the harvesting of a threshold number of crops. The captured data relating to an action may further include animated or graphical output that is part of a replayed animated event sequence. This graphical output, such as the rendered images of a scene, may be captured in addition to one or more parameters that define game state at the capture of any given action. Game state parameters may include various attributes of a user's avatar, as well as other objects in the game such as Non-player characters, other player characters and objects (such as background objects (buildings, streets) and possessions of the player characters. Lastly, at step 116, the process assesses whether to continuously capture additional actions to associate with this captured event record. If the current event capture is a discrete event capture or if a continuous event capture is deemed complete, then the process ends at step 120. On the other hand, if the current event capture is a continuous event capture, then when the underlying game logic calls the event capture module to capture an action, the entry point is at step 118 of the process flow; accordingly, when called, the process proceeds to capture the next action by repeating steps 110-114, until the process has captured all actions contributing to the event or an achievement has been reached. Thus, FIG. 1 illustrates an exemplary process flow for generating event capture records. The disclosed process flow is non-limiting. As a result, the present disclosure envisions modifications to this process flow or alternate process flows for capturing events associated with achievements.

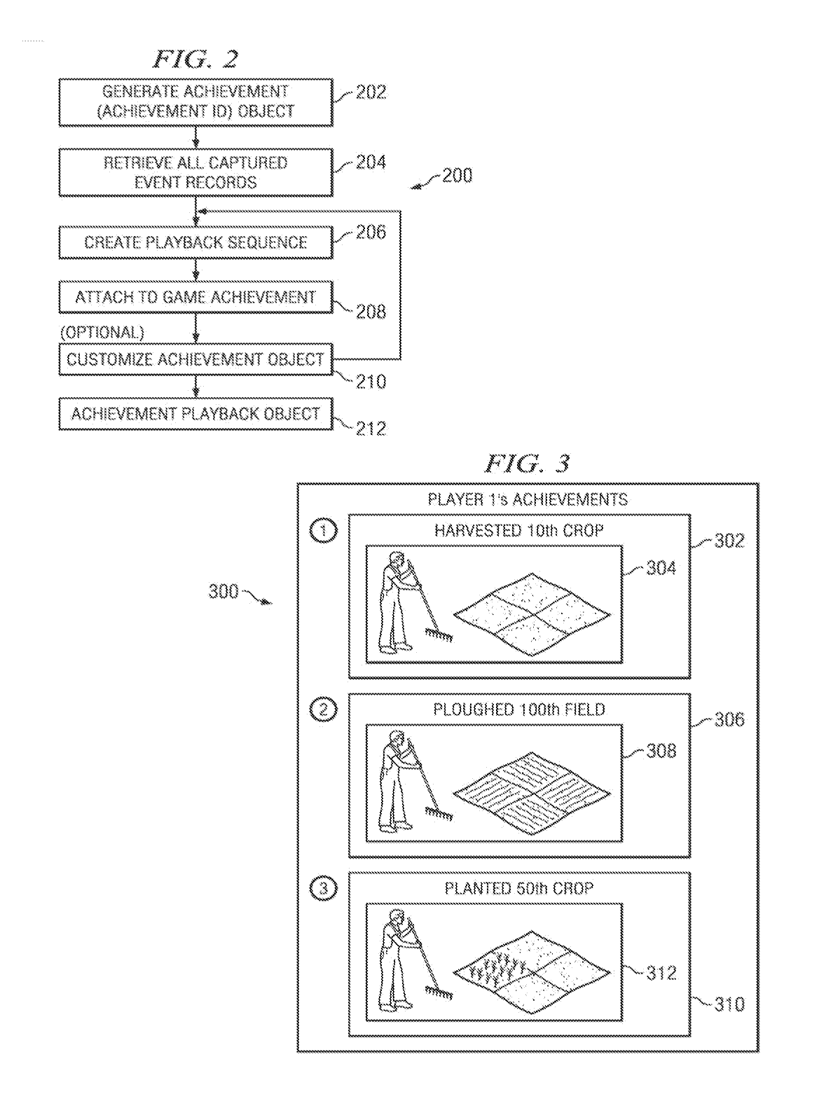

As illustrated by FIG. 2 and implemented by certain embodiments of the present disclosure, after an achievement has been reached, an achievement playback object can be generated according to an exemplary process flow 200. Game logic can control when generation of the achievement object is initiated. In some implementations, the achievement object can be automatically generated upon detection that a user has performed all tasks required by the particular achievement object. In other implementations, a batch process can scan event records and determine whether achievement milestones have been achieved and separately notify the affected user(s). The process begins at 202 by receiving an achievement identifier corresponding to a unique achievement. Next at step 204, the process retrieves all captured event records associated with the identified achievement. Then, the process automatically creates a playback sequence by aggregating the various captured event records at step 206.

The nature of the playback sequence varies according to the particular embodiments of the online gaming system. For example, for a page-based game this playback may entail automatically creating an animation of the turn-by-turn events that contribute to the particular achievement. Such an animation would not depict the actual moves taken by the user as he clicked through the pages of the game. Instead, the playback would be a animated reconstruction of the relevant events that led to the successful achievement. Thus, the resulting animated reconstruction of events leading to an achievement may be of higher fidelity than the actual user experience as presented during the online game. For example, in one implementation, each event may be associated with an animation sequence template that can be augmented and/or customized. In addition, individual animation sequences corresponding to a set of events that comprise an achievement can be aggregated for purposes of creating the achievement object.

In certain embodiments where the user interface to an online game is provided through a Flash object, the playback sequence could involve playing back animated sequences of the actual events as they originally occurred during the game. For example, as discussed above, the animated sequences can be based at least in part on the actual rendered output of the game engine as the event was captured. In some implementations, animated event sequences are based on reconstructions to permit customizations of the animated event sequences. Thus, in those embodiments the reconstruction of events leading to an achievement may be of same fidelity as the actual user experience delivered during the online game. In other embodiments, the reconstruction of events for playback could be at a reduced or enhanced fidelity. For example, even though the online Flash game itself may be animated, the playback could involve presenting snapshots of various events leading to the achievement as opposed to replaying the original animation. As described above with respect to page-based games, other embodiments using Flash could reconstruct events for playback at a higher fidelity. For instance, playback could involve presenting a high definition video or 3-dimensional reconstruction of the events that led to an achievement even though the original user experience of the online game lacked such high fidelity.

In similar fashion, the present disclosure also envisions embodiments that either increase, decrease, or maintain the fidelity of video or 3-dimensional online games during playback once an achievement is reached in the game. As a result, the playback could be, for example, in the form of high definition video, flash animation, still snapshots or the same video/3-dimensional rendering as the actual game. Thus, achievement playback sequences can take on a variety of forms and of disparate fidelity, as may be programmatically determined by particular online game architects or programmers.

Once the playback sequence is automatically generated at step 206, the process proceeds to step 208 where the playback sequence is attached to the game achievement object. This association facilitates the later playback of events related to a particular achievement. Next in optional step 210, the user is presented with a user interface to customize the achievement object. As will be described in further detail below, this step allows the user to modify the automatically generated playback sequence before it is finalized or displayed to others. Following this optional step, the process ends at step 212 by creating an achievement playback object. The achievement playback object is operable, for example, to be displayed to the user or posted to a news feed, electronic leaderboard, ranking table, or other list, thereby making it viewable by the online game community corresponding to the particular online game. In certain embodiments, an achievement playback object may be presented in a graphical representation such as an rendered image of the playback sequence. Such a graphical representation may be transmitted to a remote host so that the remote host can later playback the events leading to the particular achievement, once a particular region of the graphical representation is activated.

Accordingly, FIG. 2 illustrates a process flow for generating achievement playback objects as a non-limiting example. As such, the present disclosure envisions modifications to this exemplary process flow or alternate process flows for generating achievement playback objects. In one implementation, the achievement object that is generated includes a graphical definition of an achievement award (e.g., a badge, a plaque, a medal, etc.) and one or more animated event sequences that are played back when the achievement object is activated. In one implementation, the achievement object may itself by a FLASH-based SWF object.

In FIG. 3 a schematic view of a web page for displaying achievements for a particular user is shown generally at 300. In this exemplary view, various achievements for a particular player in an online game are displayed. Certain embodiments may present this page once an achievement is reached or when specifically requested by the player. The exemplary view displays one or more achievements 302, 306, and 310 which correspond to milestones reached by the user in the game. As illustrated, achievement 302 corresponds to the player having harvested his tenth crop. Such an achievement may comprise one or more achievement playback objects 304 which arc operable to playback relevant events associated with the particular achievement. In similar fashion, achievements 306 and 310 may comprise one or more achievement playback objects 308 and 312, respectively, where each achievement playback object is operable to playback relevant events associated with achievements 306 and 310. Thus, as the exemplary schematic view of FIG. 3 illustrates, online games can present users with the ability to recount events leading to their achievements in the game through an interface for playback of those events. Such playbacks would be automatically generated upon reaching an achievement, or some user-customized form of the automatically generated playback. Therefore, the exemplary schematic view of FIG. 3 advantageously enables users to keep track of their achievements, and retrace the steps they took to reach each. In some implementations, the achievement object displayed to the user within the context of a collection of achievement objects can have a level of animation. For example, achievement object 304 can be animated such that the character performs a “harvesting” action as it is displayed to the user. As discussed above, the underlying animated event sequence can be displayed with the user selects or activates the achievement object.

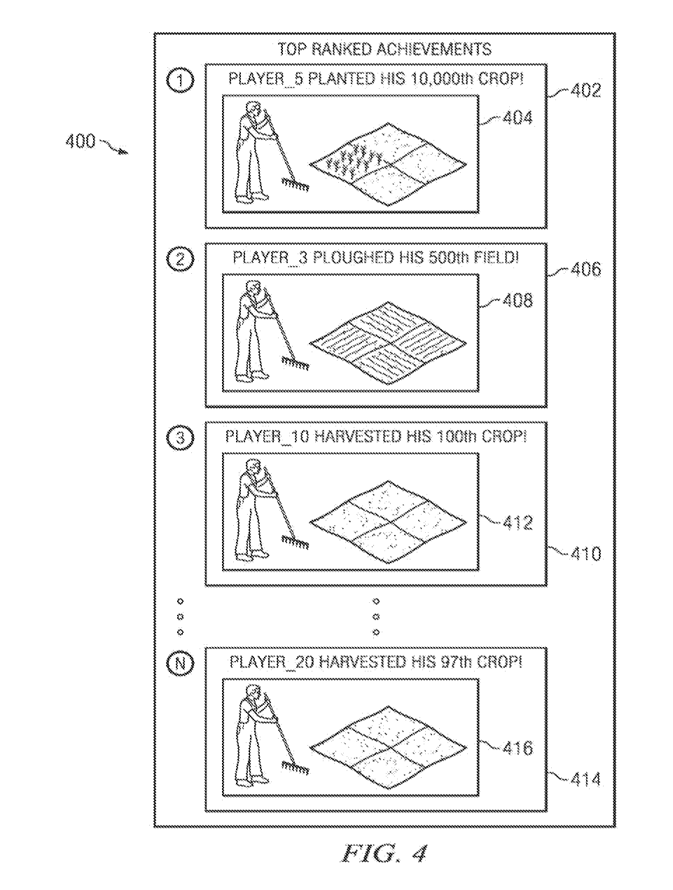

FIG. 4 illustrates a schematic view of a leader board 400 for listing achievements of multiple users in a particular gaming community. In particular embodiments, the leader board 400 lists various achievements 402, 406, 410, 414 by different users in an online gaming community. Typically the leader board would be viewable by all users or some subset users (such as users with connections in a social network) in the online gaming community. Certain embodiments would involve ranking achievements reached by different users in order of significance which would be programmatically determined by the online game and/or determined based on feedback ratings of other users in the online gaming community. For example, an achievement 402 may correspond to a player, specifically Player_5, in an online farming game (e.g., Farmville) planting his ten thousandth crop. When Player_5 actually performs this achievement, the leader board 400 can be updated with the achievement 402 and a corresponding rank. Further, the achievement 402 could comprise one or more achievement playback objects 404. These achievement playback objects 404 may correspond to an automatically generated playback sequence or a user-customized version of an automatically generated playback sequence. In similar fashion, achievements 406, 410, 414 may comprise one or more achievement playback objects 408, 412, 416, respectively. Each of those achievement playback objects are operable to recount or playback events that led to their corresponding achievement.

Thus, as illustrated by FIG. 4, an online gaming leader board 400 can be periodically updated with achievements having playback functionality when the achievements themselves are attained by individual users in an online gaming community. Such updates to a readily accessible leader board 400 and the customizable aspects of the achievement objects foster competition and interaction among users in an online gaming community thereby increasing the popularity of the online game. The achievement playback objects further enable users to showcase their skill or steps taken to reach a particular achievement. In some embodiments, this ability to gain a glimpse into other user's achievements may indirectly challenge other users to meet or surpass those achievements, thereby further promoting competition in the online game. Therefore, embodiments of the present disclosure can advantageously contribute to an online game's success.

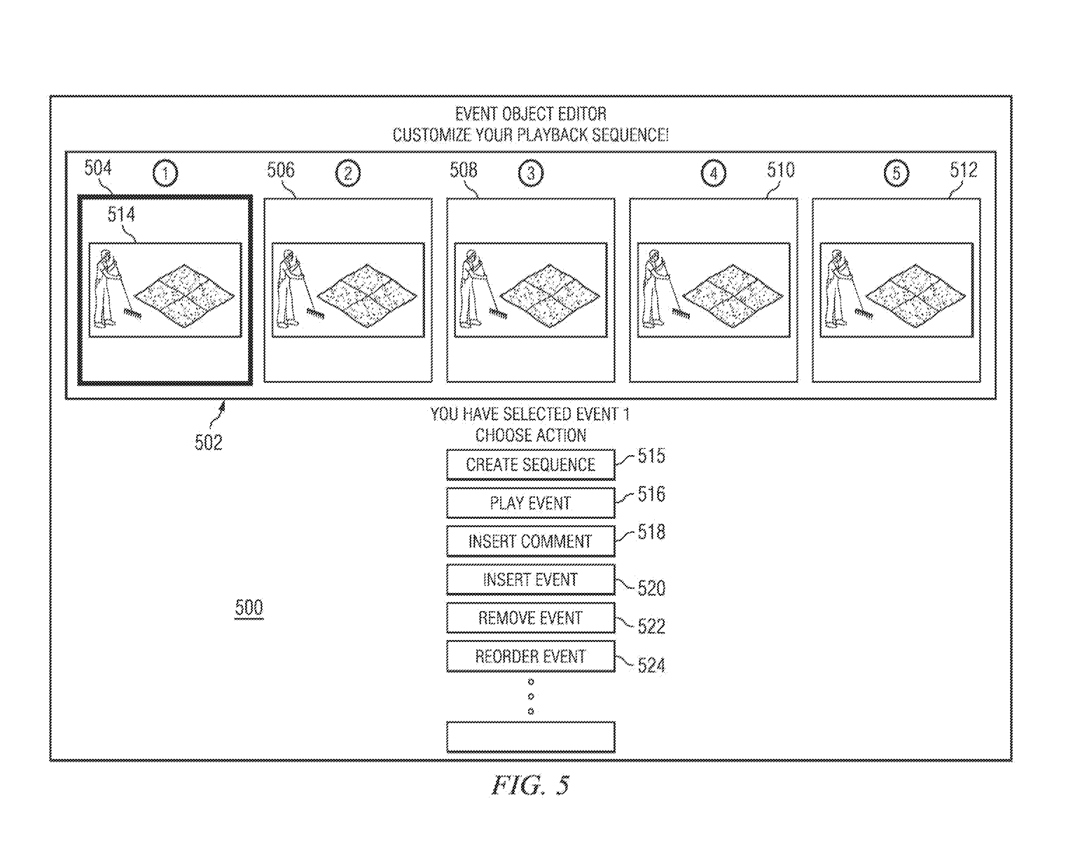

FIG. 5 illustrates an event object editor 500 for customizing playback events related to an achievement reached by a user in an online game. Once users reach an achievement, the event object editor 500 allows them to customize the playback of events contributing to their achievement. For instance, in certain embodiments, the user interface for an event object editor 500 would first present an event playback sequence 502 that was either automatically generated or the result of previous customization by the user. An event playback sequence is a series of one or more events that can be customized by a user and played back by different users in an online game community. Usually every event is in at least one event playback sequence, specifically an event playback sequence with just that event in it. In particular embodiments, events may be part of more than one event playback sequence, where each event playback sequence may include different events and comments. Event playback sequences, like events, may also be ranked and shared in an online game community. As illustrated, the event playback sequence 502 may comprise multiple events 504, 506, 508, 510, and 512. Typically, each event has some significance in relation to the overall achievement.

The event object editor 500 permits the user to select a particular event and customize it for playback. For example, the event object editor 500 of FIG. 5 illustrates that event 504 has been selected. Various exemplary actions 515, 516, 518, 520, and 522 illustrate different operations that can be performed with respect to selected event 504. For instance, create sequence action 515 enables a user to create a new event playback sequence involving the selected event 504. Play event action 516 allows the user to play the selected event 504. Similarly, the insert comment action 518 enables the user to enter a comment in the form of text or audio or video into the selected event 504 so that it can be incorporated into the event for playback. Insert event action 520 allows the user to add another event to the playback sequence that was either not included or was previously deleted from the original playback sequence 502. The user also has the option of deleting the selected event 504 by choosing remove event action 522. On the other hand, reorder event action 524 enables reordering of a selected event 504 in the playback sequence 502 in relation to other playback events 506, 508, 510, and 512. These various exemplary actions are non-limiting and thus many other actions can be incorporated into the event object editor 500 without departing from the spirit of the present disclosure. Thus, using the exemplary event object editor 500 and various actions provided by the user interface, an online game user can customize the events that arc played back upon attaining a particular achievement.

Some embodiments may extend user customization of event playback sequences to allow users of an online community to share or comment on an event playback sequence embodied in another user' achievement object using another event playback sequence, such as their own. Thus, for example, a user of an online community may view an achievement object of another user in a newsfeed or leaderboard and wish to post an achievement object having their own event playback sequence as a responsive achievement object. In other implementations, the users may insert their own comments in the achievement objects of another user using editing functions described above.

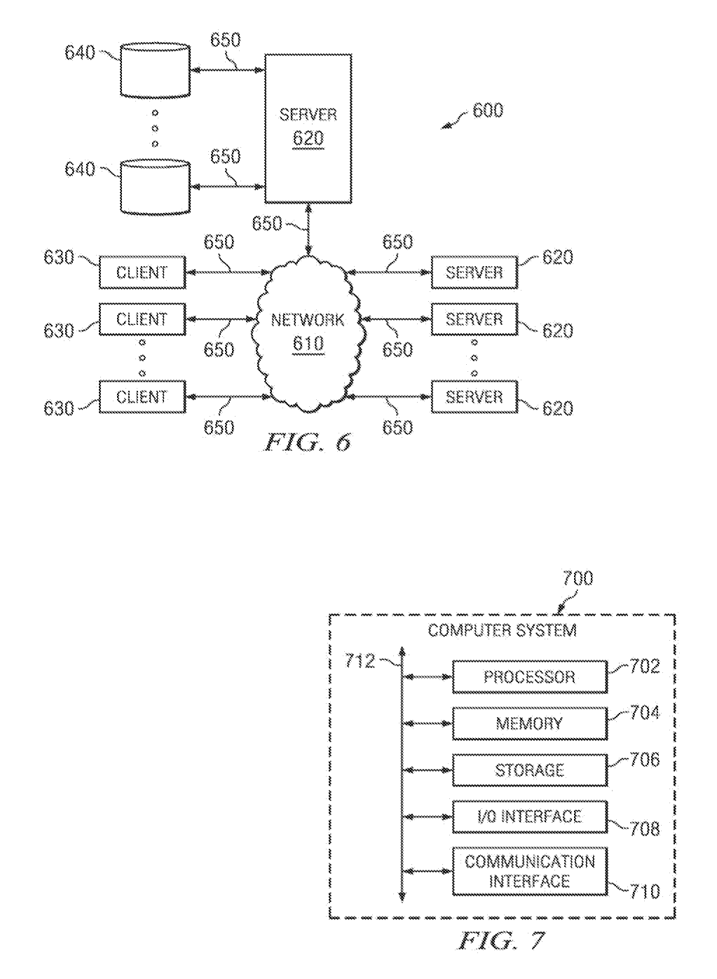

Particular embodiments may be implemented in a network environment. FIG. 6 illustrates an example network environment 600 suitable for providing software validation as a service. Network environment 600 includes a network 610 coupling one or more servers 620 and one or more clients 630 to each other. In particular embodiments, network 610 is an intranet, an extranet, a virtual private network (VPN), a local area network (LAN), a wireless LAN (WLAN), a wide area network (WAN), a metropolitan area network (MAN), a mobile telephone network, a wired telephone network, a portion of the Internet, or another network 610 or a combination of two or more such networks 610. The present disclosure contemplates any suitable network 610.

One or more links 650 couple a server 620 or a client 630 to network 610. In particular embodiments, one or more links 650 each includes one or more wireline, wireless, or optical links 650. In particular embodiments, one or more links 650 each includes an intranet, an extranet, a VPN, a LAN, a WLAN, a WAN, a MAN, a portion of the Internet, or another link 650 or a combination of two or more such links 650. The present disclosure contemplates any suitable links 650 coupling servers 620 and clients 630 to network 610.

In particular embodiments, each server 620 may be a unitary server or may be a distributed server spanning multiple computers or multiple datacenters. Servers 620 may be of various types, such as, for example and without limitation, web server, news server, mail server, message server, advertising server, file server, application server, exchange server, database server, or proxy server. In particular embodiments, each server 620 may include hardware, software, or embedded logic components or a combination of two or more such components for carrying out the appropriate functionalities implemented or supported by server 620. For example, a web server is generally capable of hosting websites containing web pages or particular elements of web pages. More specifically, a web server may host HTML files or other file types, or may dynamically create or constitute files upon a request, and communicate them to clients 630 in response to HTTP or other requests. A mail server is generally capable of providing electronic mail services to various clients 630. A database server is generally capable of providing an interface for managing data stored in one or more data stores.

In particular embodiments, one or more data storages 640 may be communicatively linked to one or more severs 620 via one or more links 650. In particular embodiments, data storages 640 may be used to store various types of information. In particular embodiments, the information stored in data storages 640 may be organized according to specific data structures. In particular embodiment, each data storage 640 may be a relational database. Particular embodiments may provide interfaces that enable servers 620 or clients 630 to manage, e.g., retrieve, modify, add, or delete, the information stored in data storage 640.

In particular embodiments, each client 630 may be an electronic device including hardware, software, or embedded logic components or a combination of two or more such components and capable of carrying out the appropriate functionalities implemented or supported by client 630. For example and without limitation, a client 630 may be a desktop computer system, a notebook computer system, a netbook computer system, a handheld electronic device, or a mobile telephone. The present disclosure contemplates any suitable clients 630. A client 630 may enable a network user at client 630 to access network 630. A client 630 may enable its user to communicate with other users at other clients 630.

A client 630 may have a web browser, such as Microsoft Internet Explorer, Google Chrome, Apple Safari or Mozilla Firefox, and may have one or more add-ons, plug-ins, or other extensions, such as Toolbar or Yahoo Toolbar. A user at client 630 may enter a Uniform Resource Locator (URL) or other address directing the web browser to a server 620, and the web browser may generate a Hyper Text Transfer Protocol (HTTP) request and communicate the HTTP request to server 620. Server 620 may accept the HTTP request and communicate to client 630 one or more Hyper Text Markup Language (HTML) files responsive to the HTTP request. Client 630 may render a web page based on the HTML files from server 620 for presentation to the user. The present disclosure contemplates any suitable web page files. As an example and not by way of limitation, web pages may render from HTML files, Extensible HyperText Markup Language (XHTML) files, or Extensible Markup Language (XML) files, according to particular needs. Such pages may also execute scripts such as, for example and without limitation, those written in Javascript, Java, Microsoft Silverlight, combinations of markup language and scripts such as AJAX (Asynchronous Javascript and XML), and the like. Web pages may also deliver interactive content presented technologies such as Flash by Adobe Systems Inc. Video or 3-dimensional rendering can also be presented within the context of a web browser. Herein, reference to a web page encompasses one or more corresponding web page files (which a browser may use to render the web page) and vice versa, where appropriate.

Particular embodiments may be implemented on one or more computer systems. FIG. 7 illustrates an example computer system 700 which could be used to implement a client or a server system in the above-described embodiments. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 700 may include one or more computer systems 700; be unitary or distributed; span multiple locations; span multiple machines; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. The present disclosure contemplates processor 702 including any suitable number of any suitable internal caches, where appropriate. As an example and not by way of limitation, processor 702 may include one or more instruction caches, one or more data caches, and one or more translation look-aside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. The present disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include an HDD, a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure-contemplates any suitable storage.

In particular embodiments, I/O interface 708 includes hardware, software, or both providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch-screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these 110 devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

This disclosure contemplates one or more computer-readable storage media implementing any suitable storage. In particular embodiments, a computer-readable storage medium implements one or more portions of processor 702 (such as, for example, one or more internal registers or caches), one or more portions of memory 704, one or more portions of storage 706, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language. Some or all of the aspects of the present disclosure may be implemented in software encoded on a computer-readable storage media.

One or more aspects of the present disclosure may be implemented as executable software instructions encoded on a computer-readable storage medium. In particular, the software instructions may comprise logic for capturing events related to an achievement, generating an achievement object once an achievement is reached, optionally customizing the achievement object through an event object editor interface, and finally displaying the achievement as a graphical representation that operable to playback events leading to the achievements, as described in the present disclosure.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method comprising:
capturing events resulting from actions of a player in an online game;
generating event records for the captured events;
detecting an achievement of the player in the online game, the achievement resulting from a plurality of the captured events; and
aggregating, using at least one processor, at least some of the event records to generate an achievement playback sequence for playback of at least some of the plurality of the captured events resulting in the achievement.

2. The method of claim 1, further comprising posting the achievement playback sequence online to facilitate playback by other players of the at least some of the plurality of captured events resulting in the achievement.

3. The method of claim 2, further comprising receiving a comment regarding the achievement playback sequence from another player, and associating the comment with the achievement playback sequence.

4. The method of claim 1, further comprising tagging each of the event records with at least one achievement identifier indicating a future achievement that includes the event of the corresponding captured event record, the aggregating of the at least some of the event records comprising selecting those of the event records having an achievement identifier for the detected achievement.

5. The method of claim 1, the capturing of the events comprising capturing action metadata describing at least one action of the player included in the events.

6. The method of claim 5, the action metadata comprising a command executed by the player.

7. The method of claim 5, the action metadata comprising at least one of a position of a game object and a movement of a game object in the online game.

8. The method of claim 1, the capturing of the events comprising continuous capture of actions of the player in the online game.

9. The method of claim 1, the capturing of the events comprising capturing only actions included in the captured events.

10. The method of claim 1, the capturing of the events comprising capturing a current game state based on the current game state being unrelated to an existing captured event record.

11. The method of claim 1, the capturing of the events comprising capturing animated sequences of the events, the achievement playback sequence comprising the animated sequences of the events.

12. The method of claim 1, the capturing of the events comprising capturing action metadata describing at least one action of the player included in the event, and the aggregating of the at least some of the event records comprising constructing animation of events for the achievement playback sequence based on the action metadata of the at least some of the event records.

13. The method of claim 1, further comprising processing the achievement playback sequence to alter a visual quality of the achievement playback sequence relative to an original rendering of the events of the achievement in the online game.

14. The method of claim 1, further comprising altering the achievement playback sequence based on commands from the player.

15. A non-transitory computer-readable storage medium comprising instructions that, when executed by at least one processor of a machine, cause the machine to perform operations comprising:
capturing events resulting from actions of a player in an online game;
generating event records for the captured events;
detecting an achievement of the player in the online game, the achievement resulting from a plurality of the captured events; and
aggregating at least some of the event records to generate an achievement playback sequence for playback of at least some of the plurality of the captured events resulting in the achievement.

16. The non-transitory computer-readable storage medium of claim 15, the operations further comprising posting the achievement playback sequence online to facilitate playback by other players of the at least some of the captured events resulting in the achievement.

17. The non-transitory computer-readable storage medium of claim 15, the operations further comprising tagging each of the event records with at least one achievement identifier indicating a future achievement that includes the event of the corresponding captured event record, the aggregating of the at least some of the event records comprising selecting those of the event records having an achievement identifier for the detected achievement.

18. The non-transitory computer-readable storage medium of claim 15, the capturing of the events comprising capturing action metadata describing at least one action of the player included in the events.

19. The non-transitory computer-readable storage medium of claim 15, the capturing of the events comprising capturing animated sequences of the events, the achievement playback sequence comprising the animated sequences of the events.

20. A system configured to:
capture events resulting from actions of a player in an online game;
generate event records for the captured events;
detect an achievement of the player in the online game, the achievement resulting from a plurality of the captured events; and
aggregate at least sonic of the event records to generate an achievement playback sequence for playback of at least some of the plurality of the captured events resulting in the achievement.
